(19) United States
(12) Patent Application Publication
(10) Pub. No.: US 2003/0061922 A1
(43) Pub. Date: Apr. 3, 2003

(54) Method and apparatus for cutting film for heat-shrinking

(76) Inventors: Scott I. Biba, Luana, IA (US); Robert J. Aloisi, Kaukauna, WI (US); A. James Mallmann, New Berlin, WI (US); Larry A. Gunseor, New Glarus, WI (US)

Correspondence Address: Finnegan, Henderson, Farabow,, Garrett & Dunner, L.L.P., 1300 I Street, N.W., Washington, DC, 20005-3315, US

(21) Appl. No.: 10/183,417

(22) Filed: Jun. 28, 2002

Related U.S. Application Data
(60) Provisional application No. 60/302,033, filed on Jun. 29, 2001.

(51) Int. Cl. B65B 53/02; B26D 1/00; B26D 3/00

(52) U.S. Cl. 83/13; 53/442; 53/557; 409/231; 125/13.01

(57) ABSTRACT

A film cutter comprising an entry plate and a guard plate capable of receiving a film therebetween, wherein the guard plate is in communication with a housing plate having a lower surface and an upper surface, and wherein the housing plate lower surface has a retaining groove capable of retaining a cutting belt. The housing plate upper surface has pushing member grooves capable of receiving pushing members, the pushing member grooves having ramps. The film cutter further includes a cutting belt having cutting members, wherein the cutting belt is retained in the retaining groove, and wherein the cutting members do not extend past the guard plate when the film cutter is in a non-activated state.

### DESCRIPTION OF THE INVENTION

1. Field of the Invention

This invention pertains to an apparatus and method for cutting a thin film. In particular, this invention pertains to an apparatus and method for cutting a thin film for heat shrinking onto an open-topped container, such as a cup.

2. Background of the Invention

Presently, in the fast food drink industry, it is typical to serve a drink in a paper, plastic, or other disposable cup topped with a preformed plastic lid. The plastic lid fits relatively tightly over the brim formed at the top of, for example, a paper drink cup, and may include apertures to permit straws or openings to be formed in the lid to allow one to directly drink the contents of the cup without removing the lid.

Unfortunately, there are many problems associated with the use of these plastic lids. For example, the lids are bulky and create problems in storage and in disposal. Still further, the seal formed by the lids is dependent upon the lid being placed on properly, and can leak if not properly placed.

In order to overcome these problems, various devices and methods have been proposed in which a cover is placed on an open-topped container and then heated to shrink it into sealing engagement with the top of such a container. These prior art devices and methods, however, fail to provide a sufficiently cost efficient, easy, and inexpensive alternative to preformed rigid plastic lids. As a consequence, rigid plastic lids remain in widespread use.

Some of the main failings of these prior devices are that they are bulky, noisy, unresponsive, and expensive. Heating systems comprising blowing air over a hot element and then onto a film require large amounts of unnecessary heat, even when in standby mode, which makes temperature control very difficult. Further, continuous elevated temperatures are expensive to maintain and may be undesirable to the immediate environment.

An improvement to these prior art systems is found in a device described in U.S. Pat. No. 5,249,410, incorporated herein by reference, which uses heat shrinkable film lids having annular energy absorbent regions formed thereon, preferably by application of an energy absorbent ink such as by printing. In this device for shrinking thin film over a container to form a lid, multiple radiant energy sources are utilized. The primary radiant energy source is located closely adjacent to the lip of the cup and moves peripherally around the lid while a secondary radiant energy source is stationed over the cup. When the primary energy source is activated, energy falling upon the energy absorbent region in the film causes the film to shrink, preferentially in the area around the lip of the cup, while energy from the secondary energy source may serve to tauten up the central portion of the lid. Alternatively, multiple primary radiant energy sources can be located around the periphery of the mouth of the cup. The apparatus disclosed in the '410 patent lacks an efficient method of concentrating and redirecting energy toward the region of the film which is to be shrunk. In other arrangements, multiple energy sources at fixed locations, are provided.

In another arrangement of the above improvement, the radiant energy source includes multiple sources rotating around the circumference of the container. In still further arrangements, multiple energy sources at fixed locations, as well as fixed radiant annular energy sources, are provided.

In each of the above, the heat shrink film must be cut prior to heat shrinking the film onto the open-topped container. Prior to cutting, the film is advanced to the heat sealing area from a roll, the film being rectangular in shape. Because it is desired that the cut-out of the film be substantially circular in shape, it is necessary to cut this shape out of the rectangular film. The film used for heat shrinking is very thin, generally 75 gauge, making cutting difficult. Because the film is very thin, it is difficult to cut the entire circumference without the film tearing or moving, thereby potentially causing an uneven cut.

The present invention provides a cutting apparatus having more than two blades attached to a cutting belt. The cutting belt can be toothed or smooth. Because of the number of blades used, each blade only travels a short distance within the heat shrinking film. For example, if five blades are employed, each blade need only travel approximately one-fifth of the circumference of the film cut-out.

Further advantages of the invention will be set forth in part in the description which follows and in part will be apparent from the description or may be learned by practice of the invention. The advantages of the invention may be realized and attained by means of the instrumentalities and combinations particularly pointed out in the appended claims.

### SUMMARY OF THE INVENTION

As embodied and broadly described herein, the invention includes a film cutter comprising an entry plate and a guard plate capable of receiving a film therebetween, wherein the guard plate is in communication with a housing plate having a lower surface and an upper surface, and wherein the housing plate lower surface has a retaining groove capable of retaining a cutting belt. The housing plate upper surface has pushing member grooves capable of receiving pushing members, the pushing member grooves having ramps. The invention further includes pushing members having ramps, wherein the pushing members are positioned in the pushing member grooves of the housing plate, and wherein an end of the pushing member is in communication with a linkage member. Moreover, the invention includes a cutting belt having cutting members, wherein the cutting belt is retained in the retaining groove, and wherein the cutting members do not extend past the guard plate when the film cutter is in a non-activated state. The guard plate has positioning members, the positioning members being received by receiving holes in the housing plate, and wherein the positioning members are capable of extending through the receiving holes in the housing plate. Moreover, the guard plate further has spring members, and wherein the spring members are in communication with the housing plate.

The invention also includes a method of cutting film comprising the steps of providing a thin film between an entry plate and a guard plate, providing a housing plate disposed opposite the guard plate having a retaining groove, the retaining groove further having a cutting belt having cutting members, wherein the cutting members extend below the retaining groove, moving the housing plate towards the guard plate and entry plate such that the cutting members are in communication with the film, and rotating the cutting belt such that the cutting members rotate and cut the film.

The invention also includes an apparatus for cutting a film and heat-shrinking the film onto an open-topped container comprising a reflective hood having a reflective interior surface, a radiant energy source, and a reflective shield, wherein the reflective shield is located at or near an opening in the reflective hood, the reflective hood and the reflective shield being configured to concentrate radiant energy from the radiant energy source about the periphery of the opening in the hood. A film cutter is in communication with the reflective hood system, wherein the film cutter is capable of cutting the film. The film cutter further comprises an entry plate and a guard plate capable of receiving a film therebetween, the guard plate in communication with a housing plate having a lower surface and an upper surface, wherein the housing plate lower surface has a retaining groove capable of retaining a cutting belt and wherein the upper surface has pushing member grooves capable of receiving pushing members, the pushing member grooves having ramps, pushing members having ramps, wherein the pushing members are positioned in the pushing member grooves of the housing plate, and a cutting belt having cutting members, wherein the cutting belt is retained in the retaining groove, and wherein the cutting members do not extend past the guard plate when the film cutter is in a non-activated state.

Still further, the invention includes a method for cutting a film and heat-shrinking the film onto an open-topped container comprising providing a thin heat-shrink film between an entry plate and a guard plate, providing a housing plate disposed opposite the guard plate having a retaining groove, the retaining groove further having a cutting belt having cutting members, wherein the cutting members extend below the retaining groove, moving the housing plate towards the guard plate and entry plate such that the cutting members are in communication with the film, and rotating the cutting belt such that the cutting members rotate and cut the film. And, contacting the opening of an open-topped container with the heat shrink film, placing the covered open-topped container at an opening of a reflective hood, wherein a portion of the opening of the reflective hood is covered by a reflective shield, and activating a radiant energy source, the radiant energy source emitting radiant energy, wherein a first portion of the radiant energy reflects along a surface of the reflective hood and is ultimately directed to an area below the brim of the open-topped container, thereby shrinking the heat-shrink film and wherein, the portion of the heat-shrink film located under the reflective shield is substantially shielded from impingement by the first portion of radiant energy.

The accompanying drawings, which are incorporated herein and constitute a part of this specification, illustrate an embodiment of the invention, and, together with the description, serve to explain the principles of the invention.

### BRIEF DESCRIPTION OF THE DRAWINGS

FIG. 1 is an exploded view of a film cutter according to an embodiment of the present invention.

FIG. 2 is another exploded view of a film cutter according to an embodiment of the invention.

FIG. 3 is a schematic of the driver portion of a film cutter according to an embodiment of the invention.

FIG. 4 is a perspective view of the top half of the film cutter according to an embodiment of the present invention.

FIG. 5 is a perspective view of the film cutter according to an embodiment of the present invention.

FIG. 6 is another perspective view of the film cutter according to an embodiment of the present invention.

FIG. 7 is a sectional view of the film cutter according to an embodiment of the present invention.

FIG. 8 is another sectional view of the film cutter according to an embodiment of the present invention.

FIG. 9 is a top view of a film cutter cutting portion according to another embodiment of the present invention.

FIG. 10 is a view of a reflective hood for use with the current invention.

FIG. 11 is a view of a double ellipsoidal reflective hood for use with the current invention.

FIG. 12 is a view of a ellipsoidal/parabolic reflective hood for use with the current invention.

FIG. 13 is a perspective view of an embodiment of a cutting belt according to the present invention.

### DESCRIPTION

Reference will now be made in detail to the present embodiments of the invention, examples of which are illustrated in the accompanying drawings. While the following description is directed to a film cutter capable of cutting film for open-topped containers, such as cups, those of ordinary skill in the art will appreciate that the invention is equally applicable film cutters capable of cutting film for other open-topped containers, such as food cartons. The film can be cut in a variety of shapes, such as circular, oval, etc.

In accordance with the invention, as broadly described, the film cutter includes a cutting apparatus and a cutting belt or gear having at least two cutting blades. The invention may further include an entry plate and a guard plate, a thin film capable of passing therebetween. The invention further includes a housing plate capable of housing the belt or gear having at least two cutting blades mounted thereon, and ramps and a linkage gear for engaging the blades. The invention may further include a locking plate which prevents engagement of the blades when the entry and guard plates are separated for maintenance.

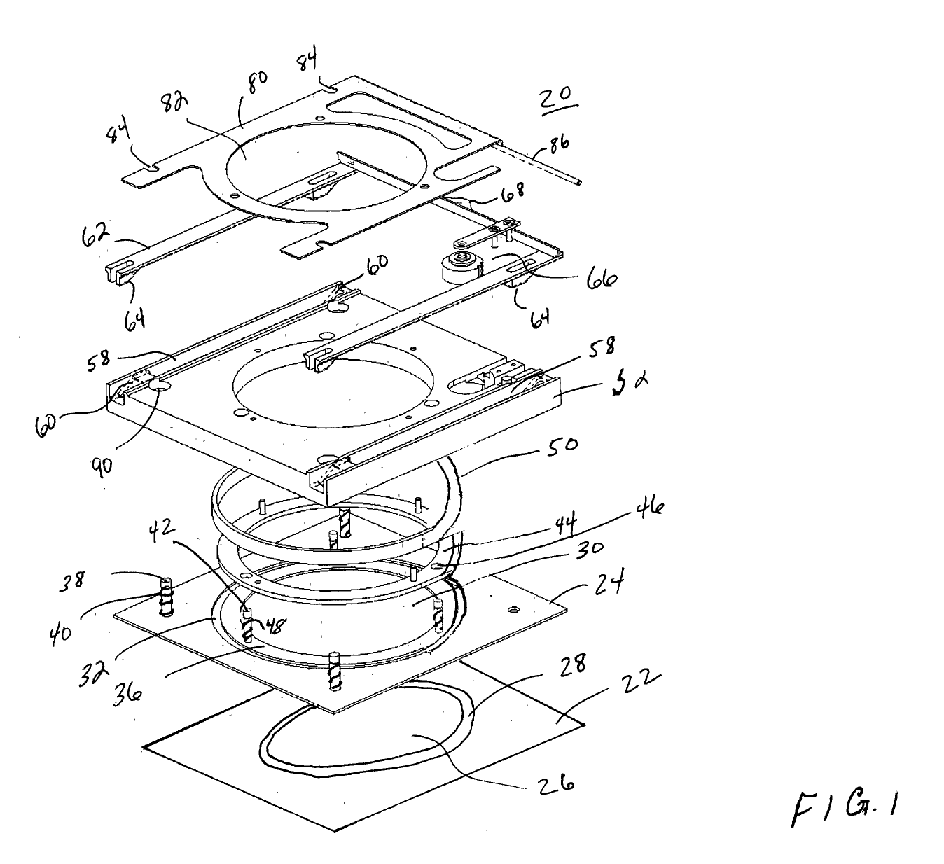

In one embodiment, as shown in FIG. 1, the film cutter 20 includes an entry plate 22 disposed opposite a guard plate 24. The entry plate 22 may be hinged so that it can be moved away from the guard plate 24, i.e., from a closed position or operating position to an open position, for insertion of film or when maintenance on the film cutter 20 is required. When the entry plate 22 and guard plate 24 are in the closed position, a thin film (not shown) can pass therebetween. The entry plate 22 may have an opening 26 for receiving an open-topped container (not shown). The entry plate 22 may be substantially rectangular and the opening 26 may be substantially circular. Other shapes would be readily apparent to the skilled artisan. Moreover, it is preferred that the opening 26 have a diameter slightly larger than the outside brim diameter of the largest beverage container 16 to be lidded with the device, for example 4.00″. In one embodiment the opening 26 has a diameter of at least approximately 4.25″. In the embodiment depicted in FIG. 1, the entry plate 22 has a groove 28 for receiving the cutting members 56 (cutting members 56 not shown in FIG. 1) when the film cutter 20 is engaged.

The guard plate 24 may be similar in shape to the entry plate 22. In particular, the guard plate 24 may be substantially rectangular. The guard plate can have an opening 30 provided for receiving an open-topped container and the opening 30 may be substantially circular. Other shapes would be readily apparent to the skilled artisan. The guard plate opening 30 should be in alignment with the entry plate opening 26 when the cutter is in the closed position. A guard plate inner ring 36 is positioned in the opening forming a guard plate groove 32, located between the guard plate 24 and the inner ring 36, for receiving the cutting members 56 when the film cutter 20 is engaged. The entry plate 22 and the guard plate 24 and the guard plate inner ring 36 should be in alignment when the film cutter 20 is in the closed position, such that the guard plate groove 32 and entry plate groove 28 are likewise in alignment. In the embodiment depicted in FIG. 1, the grooves 28, 32 are substantially circular. Those of ordinary skill in the art will understand that a variety of shapes are available.

In one embodiment the guard plate 24 has positioning members 38 located on the periphery of the guard plate 24. The positioning members 38 extend upwardly and are in communication with, and are capable of extending through, a housing plate 52. The guard plate 24 may have spring members 40 located on the periphery of the plate 24. In the embodiment depicted in FIG. 1, the spring members 40 are located on the positioning members 38, and are in communication with the housing plate 52. The spring members 40 are capable of maintaining a separation between the guard plate 24 and the housing plate 52 when the spring members 40 are not compressed. Those of ordinary skill in the art will understand that the spring members 40 can be separately located from the positioning members 38. Moreover, those of ordinary skill in the art will understand that the spring members 40 can be vertical coil springs, as shown in FIG. 1, or can be a variety of other members, which may or may not be spring-like, but which are capable of achieving the appropriate separation.

The guard plate inner ring 36 may have positioning members 42 that extend upwardly. The positioning members 42 extend through a retaining ring 44 and are in communication with, and are capable of extending through, the housing plate 52. In this embodiment the retaining ring 44 has holes 46 through which the positioning members 42 extend. Spring members 48 are located on the inner ring positioning members 42 and are in communication with the retaining ring 44. As with the guard plate spring members 40, the guard plate inner ring spring members 48 can be located on the positioning members 42 or can be separately located. The inner ring spring members 48 are capable of maintaining a separation between the guard plate inner ring 36 and the retaining ring 44 when the spring members 48 are not compressed. Moreover, those of ordinary skill in the art will understand that the spring members 48 can be vertical coil springs, as shown in FIG. 1, or can be a variety of other separation members. The retaining ring 44 may be fastened directly to the housing plate 52.

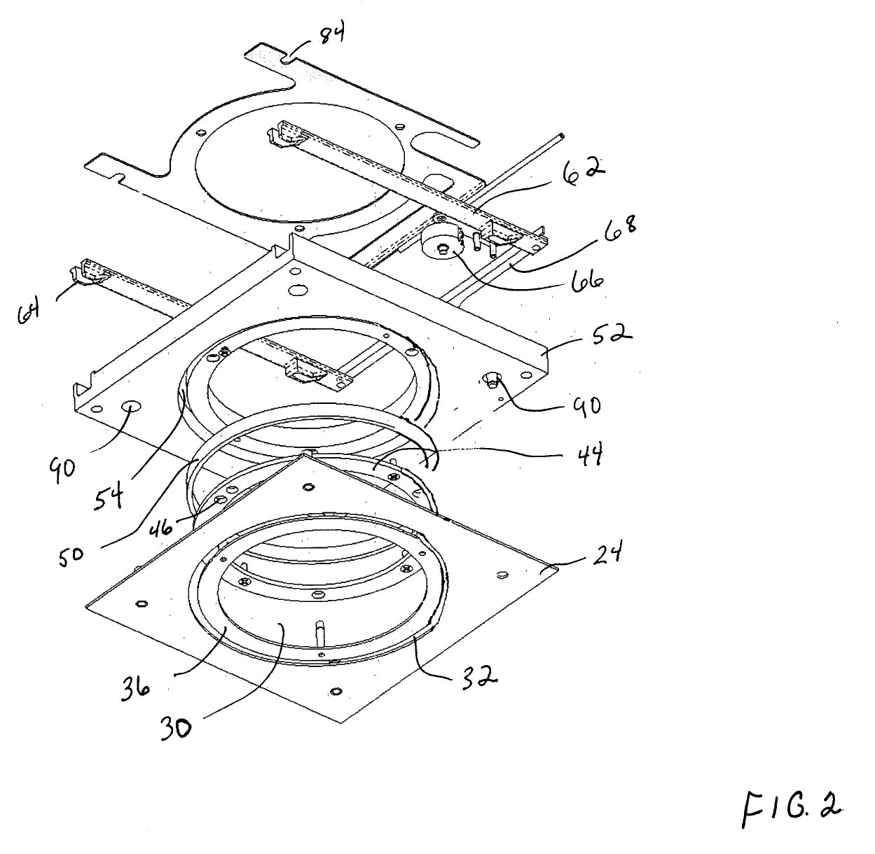

In the embodiment shown in FIG. 2, the housing plate 52 has a retaining groove 54 on the lower side facing the guard plate 24. The retaining groove 54 is capable of housing a cutting belt 50. The cutting belt 50 can be smooth, or it can be toothed, such as a timing or gear belt. The cutting belt 50 depicted in FIG. 1 is a toothed gear belt. The retaining ring 44 is sized such that its outer diameter extends over a portion of the inner diameter of the retaining groove 54 and is capable of retaining the cutting belt 50 in the retaining groove 54. The housing plate 52 may also have receiving holes 90. The receiving holes 90 extend through the housing plate 52 and are capable of receiving the guard plate positioning pins 38 and the inner ring positioning pins 42.

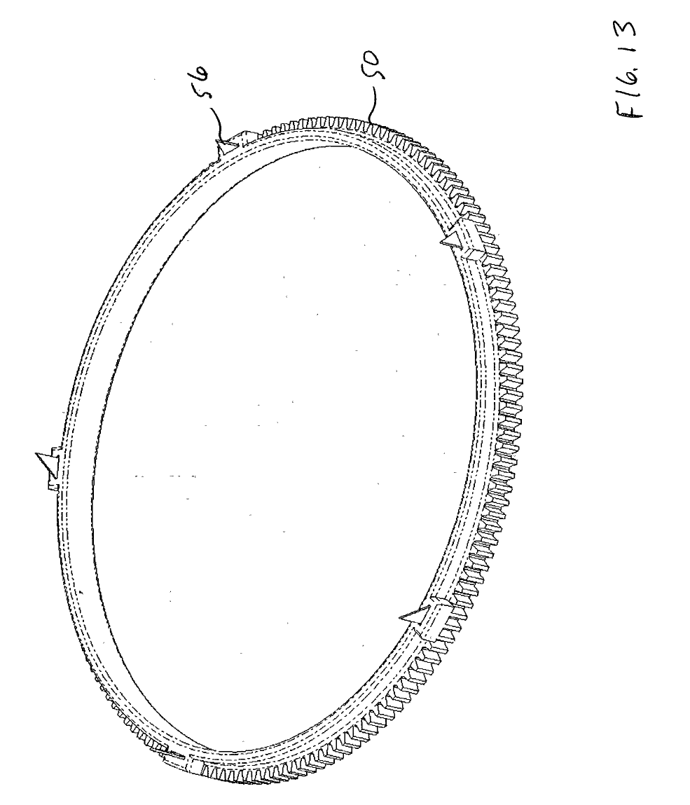

The cutting belt 50 may have cutting members 56 (see FIG. 13), such as blades, mounted on the periphery of the cutting belt 50 extending downwardly. When the cutting belt 50 is secured in the retaining groove 54, the cutting members 56 extend past the retaining ring 44. The cutting belt 50 may have at least two cutting members 56. In one embodiment, the cutting belt 50 has five cutting members 56. In another embodiment, the cutting belt 50 has three or four cutting members 56. Those of ordinary skill in the art will understand that any number of cutting members 56 can be used in this invention.

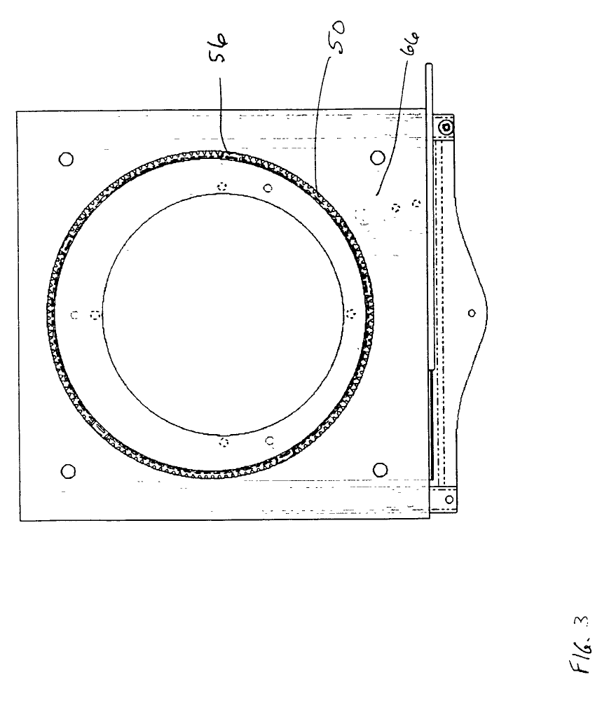

A cutting belt driver 66, as shown in FIG. 3, may be in communication with the cutting belt 50. If the cutting belt 50 is toothed, the cutting belt driver 66 can be a toothed gear, as shown in FIG. 1. If a smooth cutting belt 50 is used, the cutting belt driver 66 can be a pulley. When the cutting belt driver 66 is moved, the cutting belt 50 is likewise moved, causing the cutting members 56 to rotate such that they are capable of cutting a thin film. The cutting belt driver 66 is driven by a belt or chain (not shown).

In one embodiment, as shown in FIG. 1, the upper surface of the housing plate 52 has elongated pushing member grooves 58 located on opposite sides of the housing plate 52. On each end of each of the pushing member grooves 58 are ramps 60 that extend from the bottom of the pushing member groove 58 toward the upper surface of the housing plate 52. Elongated pushing members 62 are located in the pushing member grooves 58. The pushing members 62 have ramps 64 located at each end. The pushing member ramps 64 mate with the pushing member groove ramps 60.

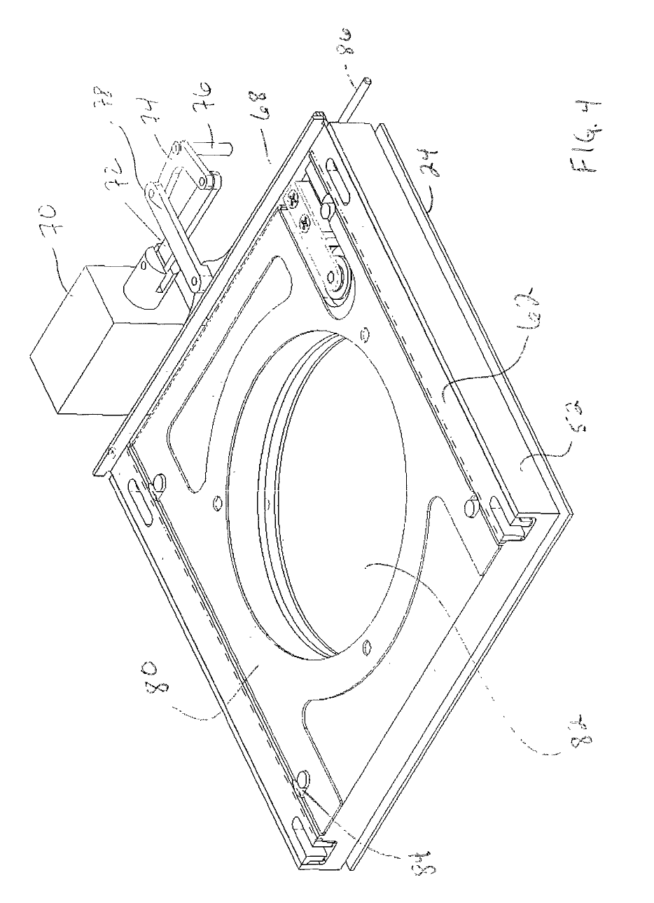

A linkage member 68 can be connected to an end of each of the elongated pushing members 62, as shown in FIG. 1. When the linkage member 68 is moved away from the housing plate 52, thereby moving the pushing members 62, the pushing member ramps 64 act downwardly on the pushing member groove ramps 60, thereby forcing the housing plate 52 downward. In one embodiment, the linkage member 68 is pulled when a solenoid 70 is activated. Those of ordinary skill in the art will understand that a variety of methods, both mechanical and electrical, can be used to move the linkage member 68. In the embodiment shown in FIG. 4, the solenoid 70 is attached to a rod 72, which in turn is attached to a pivot arm 74. The pivot arm 74 is pivotally mounted on a pivot pin 76. In addition, the pivot arm 74 is connected to a linkage plate 78, which is connected to the linkage member 68. In this embodiment, when the solenoid 70 is activated, the rod 72 moves toward the solenoid 70, thereby pivoting the pivot arm 74 which pulls the linkage plate 78. As the linkage plate 78 is connected to the linkage member 68, the linkage member 68 is likewise moved.

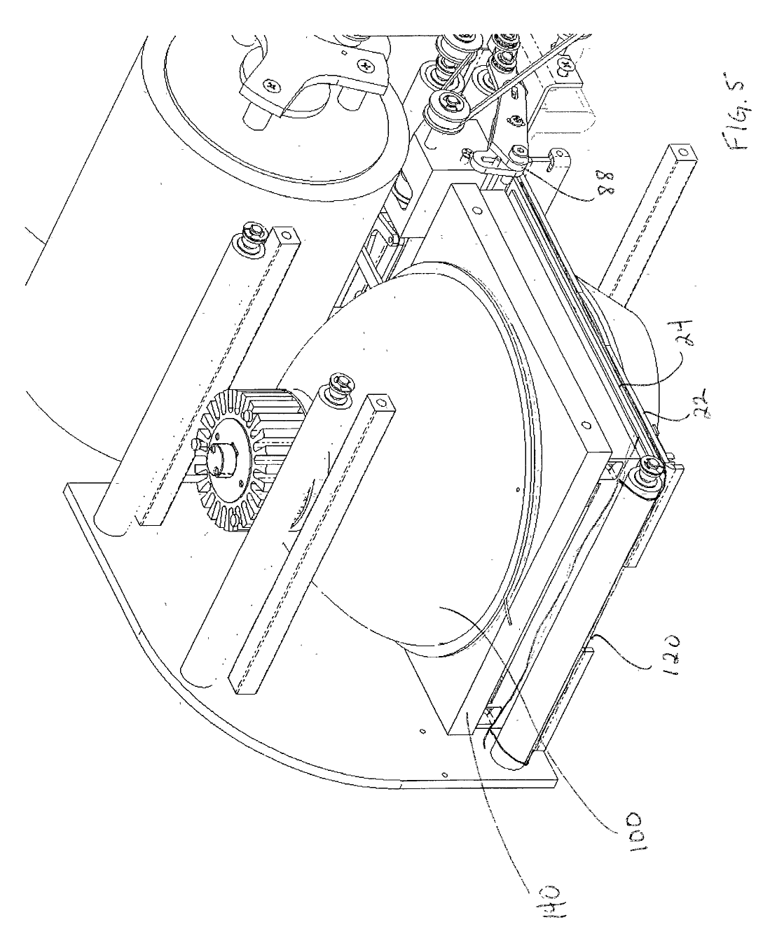

In another embodiment, the film cutter 20 has a safety plate 80, as shown in FIG. 1. The safety plate 80 is located on the upper surface of the housing plate 52. The safety plate 80 has an opening 82 for receiving an open-topped container (not shown). The safety plate may also have cutouts 84, or holes, that align with the housing plate receiving holes 90 when the film cutter 20 is in the closed position that allow the guard plate positioning pins 38 and the inner ring positioning pins 42 to extend through the upper surface of the housing plate 52. The safety plate 80 may have a rod 86 attached thereto. The rod 86 can be in communication with a safety plate linkage member 88 (FIG. 5). When the film cutter 20 is in the open position, the safety plate linkage member 88 pulls the rod 86, and, hence, the safety plate 80, such that the safety plate 80 covers the housing plate receiving holes 90. As described below, when the housing plate receiving holes 90 are covered, the positioning pins 38, 42 cannot extend above the housing plate 52 and, hence, the cutting members 56 cannot protrude beneath the guard plate 24. Thereby, the film cutter 20 can be opened for maintenance without compromising the safety of the operator.

While a cutting belt having at least three blade members has been described as being used with the above film cutter, those of ordinary skill in the art will understand that the cutting belt having three blade members can be used in any film cutting system capable of receiving a belt having blades.

When the above-described film cutter 20 is used with a shrinking device, it may be used in combination with a reflective hood as described below.

A reflective hood system may include a radiant energy source, a reflective hood, a reflective shield, and a protective optical element. In general, the radiant energy source emits radiant energy, preferably as visible and near infrared radiation. A portion of the emitted radiant energy contacts the surface of the reflective hood until finally being directed toward a thin film that will shrink when impinged on by visible and near infrared radiation. Radiant energy also reflects off the reflective shield and is directed back to the reflective hood and to the thin film.

In one embodiment of the present invention, film is provided covering the top of, and extending downwardly past the brim of, an open-topped container, such as a drinking cup. The radiant energy from the radiant energy source is directed to the area just below the periphery of the top of the cup, i.e., just below the brim. Thus, the radiant energy causes the film to shrink in the area around the brim, thereby forming a lid. The film may be a bi-axially oriented thin shrink film having a thickness of between 40 to 120 gauge (1.02 mm to 3.05 mm), with a more preferred film having a thickness of between 60 to 100 gauge (1.52 mm to 2.54 mm). One film that has been used is a 75 gauge (1.91 mm) DuPont Clysar ABL polyolefin shrink film. Appropriate shrink film would be readily apparent to the skilled artisan. Any art recognized film would be appropriate, such as 75 gauge (1.91 mm) Intertape Exfilm polyolefin shrink film. When used to cover food products, the film should be food contact-approved by the appropriate regulatory authorities.

To ensure that the film sufficiently shrinks when contacted by radiant energy, the film can be coated with a radiant energy absorbing substance. One such substance that works well in this environment is carbon black pigment. Other substances that would achieve satisfactory results include graphite and iron oxide. According to one embodiment of the present invention, the carbon black pigment may be included as a functional component in ink that is applied to the surface of the film.

In another embodiment of the present invention, at least two ink layers are applied to the film. One layer is a reflective layer and the second layer is a radiant energy absorbing layer. The radiant energy absorbing layer preferably contains an energy absorbing substance, such as carbon black, which increases the shrink rate of the film. The reflective layer acts as a reflector and reflects some of the radiant energy that passes through the energy absorbing layer back to the energy absorbing layer, thereby increasing the amount of energy absorbed by the energy absorbing layer.

Ink systems that have been found to be adequate for use with the current invention are described below. Those of ordinary skill in the art will understand that there are a variety of ink systems, having one or more ink layers, that can be used with the present invention.

According to one embodiment, in a two layer ink system, the film may include a white ink, i.e., reflective layer, and a maroon ink, i.e., energy absorbing layer. In a preferred energy absorbing layer, carbon black is mixed into the maroon layer. To enhance shrinkage of the film, it is preferred that carbon black be added at a concentration of at least approximately 6% by dry weight of the ink formulation. In addition, it is preferred that at least 0.03 lbs. of carbon black be added to every 3000 sq. ft. of printed area of the film. The white layer acts as a reflector so that the radiant energy that passes through the maroon layer will be reflected back towards the maroon layer, thereby enhancing impingement of the maroon layer by the radiant energy. While the invention has been described in terms of a white or maroon layer, those of ordinary skill in the art will appreciate that a variety of colors can be used to achieve a reflective layer and an energy absorbing layer.

In another two layer ink system, the film is coated with an aluminum particulate silver ink and then a blue or black ink, preferably with a substantial amount of a material which is highly energy absorbent for the particular energy source being utilized, such as carbon black. As with the white layer described above, the silver layer acts as a reflector so that the radiant energy that passes through the blue layer will be reflected back towards the blue layer, thereby enhancing impingement of the blue layer by the radiant energy.

A four layer ink system is preferred when lighter, more decorative, colors are desired on the top surface of the film. In particular, it is sometimes desired to apply a decorative layer above the absorbent layer. In one embodiment of a four layer ink system, the four layer ink system has a film, silver reflective layer, an absorbent layer, a white reflective layer, and a decorative layer. The decorative layer may contain multiple colors that are lighter than the maroon and dark blue generally achieved with two layer systems. The decorative layer may also contain advertising slogans and indicia useful for identifying the contents of the lidded container. Those of ordinary skill in the art will understand that a variety of layer color combinations can be used to achieve the results of the present invention.

Each of the above formulations is acceptable for use with the current invention. The four layer ink system provides for acceptable film shrink with superior appearance. The two color system achieves acceptable film shrink and appearance at a lower cost.

Those of ordinary skill in the art will understand that a variety of ink colors can be used to obtain satisfactory results with the present invention and that a variety of number of ink layers can also be used. In addition, those of ordinary skill in the art will understand that it is not necessary to coat the entire film with ink. In particular, in those area where shrinkage is not desired, the ink coating need not be applied and may, in fact, be undesirable. Moreover, those of ordinary skill in the art will appreciate that ink patterns can be used on any ink layer.

Prior to the film being subjected to radiant energy, the film may be cut using the film cutter 20 described above.

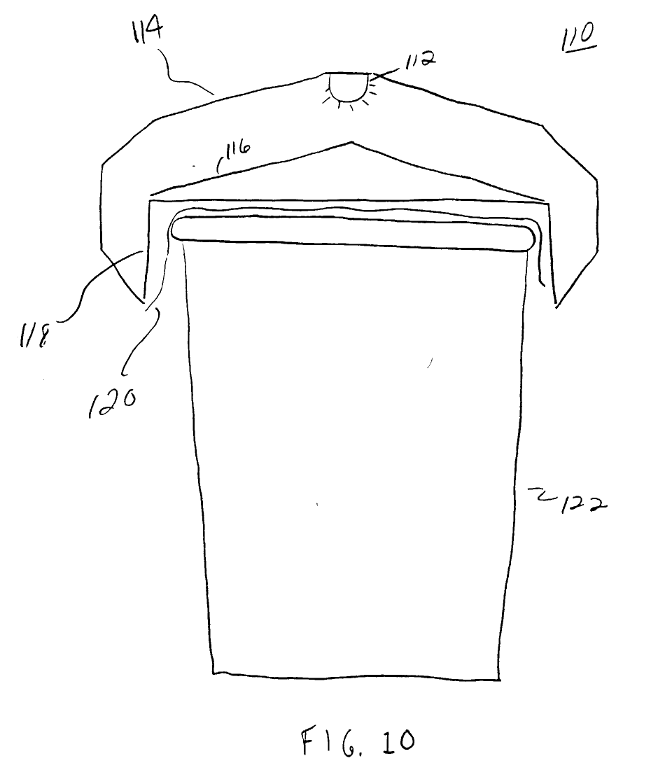

A reflective hood is shown in FIG. 10. The reflective hood assembly 110 may include a radiant energy source 112, a reflective hood 114, a reflective shield 116, and a protective optical element 118. The protective optical element 118 may be any art recognized or after developed material. The protective optical element 118 may be glass or plastic. The radiant energy source 112 produces radiant energy for shrinking a film 120 by emitting radiant energy having wavelengths in the visible and near infrared range. Those of ordinary skill in the art will understand that the wavelength of the energy emitted by the radiant energy source is not particularly critical so long as the ink chosen is sufficiently absorbent over a range of the wavelengths emitted that film shrinkage is reasonably rapid. Of course, care must be taken to ensure that the surfaces serving as reflectors are actually reflective for radiation in the chosen wavelengths if radiation outside the visible range is emitted.

In particular, a convenient radiant energy source 112 is a conventional halogen lamp emitting light energy having wavelengths at least between approximately 600-1400 nm. It has been found that tungsten halogen lamps are a preferred radiant energy source 112, however, those of ordinary skill in the art will understand that a number of different radiant energy sources are available which produce sufficient visible and near infrared radiation. The energy source is preferred to have a wattage of between 150-1000 watts for standard electrical wiring/circuitry.

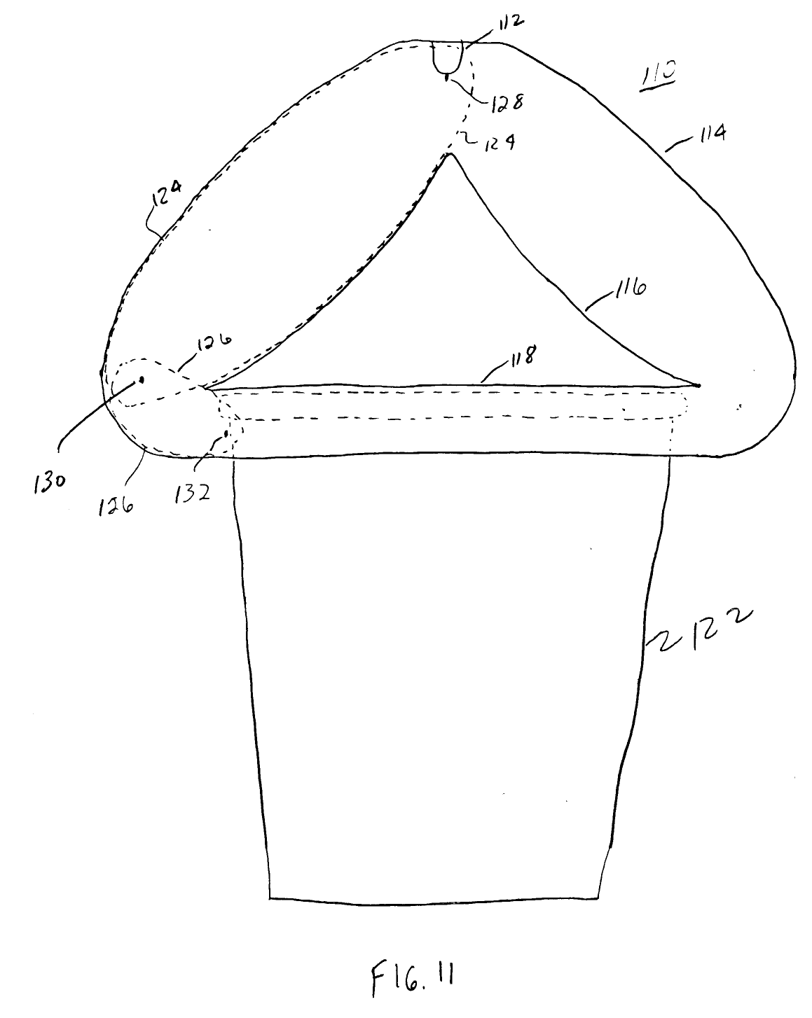

In another embodiment, as shown in FIG. 11, a double ellipsoidal structure is formed by the curvatures of the reflective hood 114 and the reflective shield 116. The reflective hood assembly 110 has a double ellipsoidal structure that improves the efficiency in delivering the radiant energy to the target shrinkage area. The first or primary ellipsoid 124 is formed by the inner surface of the reflective hood 114 and the upper surface of the reflective shield 116. Unlike the reflective hood 114 depicted in FIG. 10, the reflective hood 114 has a largely curvilinear surface of revolution. The primary ellipsoid 124 has a focal point 128 and a focal ring 130. The focal point 128 is located coincident with the radiant energy source 112, which is attached to the assembly 110 at the upper end of the primary ellipsoid 124, in the vicinity of the radiant energy source 112. The focal ring 130 is located at the lower end of the primary ellipsoid 124. In operation, the radiant energy emitted from the radiant energy source 112 passes from the focal point 128 and through the focal ring 130. Because of the curvilinear surface of revolution of the reflective hood 114 wall, the majority of the radiant energy does not flow directly from the focal point 128 through the focal ring 130, but instead contacts the reflective hood 114, will reflect off the reflective hood 114 and through the focal ring 130.

The secondary ellipsoid 126 is defined by the lower portion of the reflective hood 114. As with the primary ellipsoid 124, the secondary ellipsoid 126 has two focal rings 130, 132. The lower portion of the reflective hood 114 may be configured such that the focal ring 130 of the second ellipsoid ring is common with the first ellipsoid focal ring 130. Moreover, the lower portion of the reflective hood 114 may be configured such that the second focal ring 132 of the secondary ellipsoid 126 may be located near the shrinkage target area of the film 120. When the radiant energy passes through the secondary ellipsoid first focal ring 130, as described above, the radiant energy reflects off the surface of the reflective hood 114. Because of the curvilinear surface of revolution of the lower portion of the reflective hood 114, the radiant energy passes through the secondary ellipsoid second focal ring 132 and impinges on the film 120 at the shrinkage target area. It is preferred that the shrinkage target area be located just below the brim of the opening of the beverage container 122, such that when the radiant energy impinges on the film 120, a seal is formed below the lid of the beverage container 122.

The reflective shield 116 of the described embodiment, which substantially prevents radiant energy from impinging a portion or portions of the surface of the film 120, may be a curved reflective part of the first ellipsoidal 124 surface. The shape of the reflective shield 116, as shown in FIG. 11, is designed to reflect the radiant energy that contacts it such that it reflects off the reflective hood 114 and passes through the focal ring 130. As noted above, in one embodiment he reflective shield has a metallic mirrored surface.

Those of ordinary skill in the art will readily understand how to determine the dimensions for a double ellipsoidal reflective hood for effectively directing the radiant energy to the target area. An example of the calculations for determining the dimensions are set forth in the following example.

The following equations can be used to determine the ellipsoids:

Major Axis (length of primary ellipsoid): 2a=2b+2c

Major Axis (length of secondary ellipsoid): 2d=2e+2f

where 2b,2e=the distance between the focal points of each ellipsoid; and

c,f=the distance from foci to the edge of the ellipse at the apex.

To determine the dimensions, the “c” distance (for the primary ellipse), which is dependent upon the size and shape of the radiant energy source being used, must be selected. In addition, the distance between the focal points of the large ellipse, “2b”, which is the distance needed for the largest cup, must be selected. After determining the desired energy profile at the cup, the following selections were made:

For the primary ellipse: c=0.2″ and 2b=5″

For the secondary ellipse: f=0.2 and 2e=1″

Using the above values, the dimensions of the ellipses were determined. Understanding that the primary and secondary ellipses share a common focal point, the secondary ellipse was rotated −25 degrees about the common focal point. Then, both the primary and secondary ellipses were rotated 45 degrees about the focal point coincident with the radiant energy source.

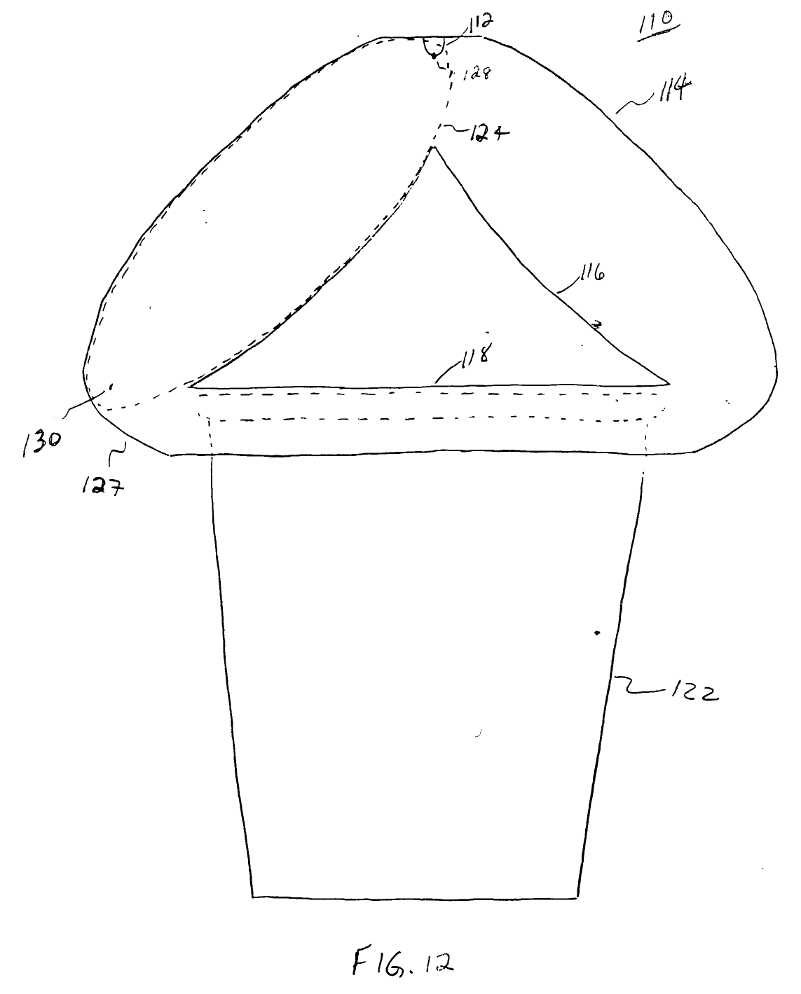

In another embodiment of the claimed invention, as depicted in FIG. 12, a single ellipsoidal/parabolic structure is formed by the curvatures of the reflective hood 114 and the reflective shield. The single ellipsoidal/parabolic structure can improve the efficiency in delivering the radiant energy to the brim of the cup when multiple cup sizes are to be used. As compared to the double ellipsoidal structure described above, which directs the radiant energy such that it converges at a target area, the single ellipsoidal/parabolic structure directs the reflected radiant energy in a substantially horizontal band towards the target area.

As described in conjunction with the double ellipsoidal structure, the primary ellipsoid 124 is defined by the uppermost portion of the reflective hood 114 and the upper surface of the reflective shield 116. Unlike the reflective hood 114 depicted in FIG. 10, the reflective hood 114 has a largely curvilinear surface of revolution. The primary ellipsoid 124 has a focal point 128 and a focal ring 130. The focal point 128 is located coincident with the focal point of the radiant energy source 112, which is attached to the assembly 110 at the upper end of the primary ellipsoid 124 in the vicinity of the radiant energy source 112. The focal ring 130 is located at the lower end of the primary ellipsoid 124. In operation, the radiant energy emitted from the radiant energy source 112 passes from the focal point 128 and through the focal ring 130. Because of the curvilinear surface of revolution of the reflective hood 114 wall, the majority of the radiant energy that does not flow directly from the focal point 128 through the focal ring 130, but instead contacts the reflective hood 114 or the reflective shield 116, will reflect off the reflective hood 114 or the reflective shield 116 and through the second focal point 130.

Unlike the double ellipsoidal structure described above, however, the lower portion of the reflective hood 114 defines a parabaloid 127. The parabaloid 127 is defined by the lower portion of the reflective hood 114. The lower portion of the reflective hood 114 is configured such that when the radiant energy passes through the focal ring 130 of the primary ellipsoid, the radiant energy reflects off the surface of the reflective hood 114 in a direction substantially horizontal to the mouth of the open-topped container. As such, because the radiant energy contacts the lower portion of the reflective hood at various locations, and because the reflected radiant energy then travels substantially horizontally towards the cup, the reflected radiant energy does not converge to a common location as with the double ellipsoidal hood. Instead, the radiant energy travels in a band the width of the vertical height of the parabaloid. Therefore, regardless of the width of the cup, or its location underneath the reflective hood, the radiant energy should contact the brim of each sized cup in generally the same area.

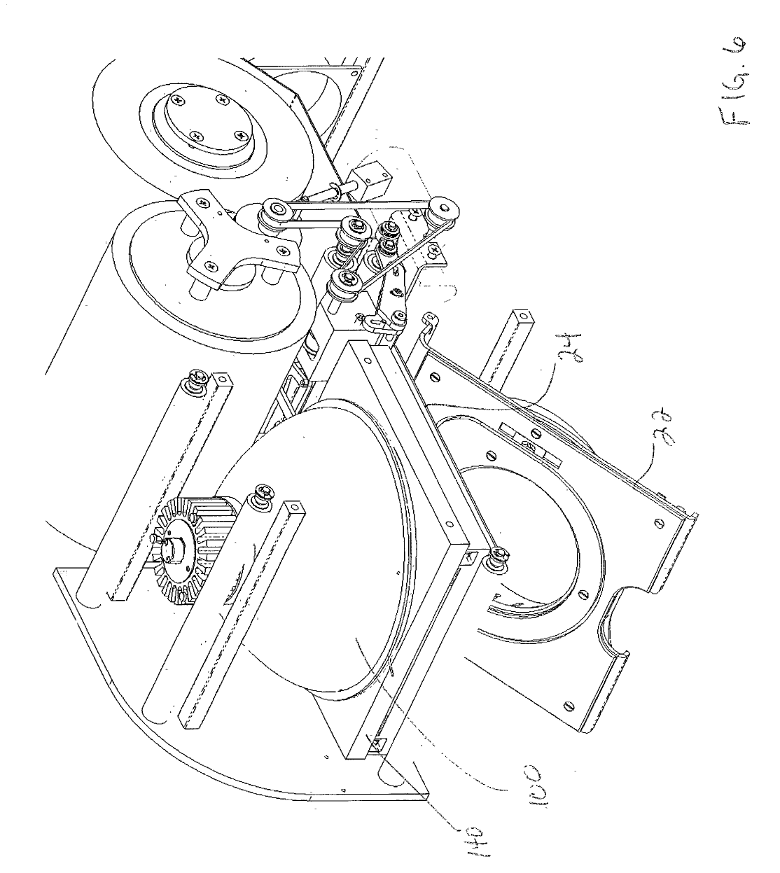

FIG. 5 depicts the film cutter 20 in use with a double-ellipsoidal reflective hood, in the closed position. FIG. 6 depicts the film cutter in use with a double-ellipsoidal reflective hood, in the open position. As shown in FIGS. 5-6, the film cutter 20 is positioned beneath the double-ellipsoidal reflective hood 100, and is attached to the double ellipsoidal reflective hood 100 via a connection plate 140. The thin film 120 is located between the entry plate 22 and the guard plate 24.

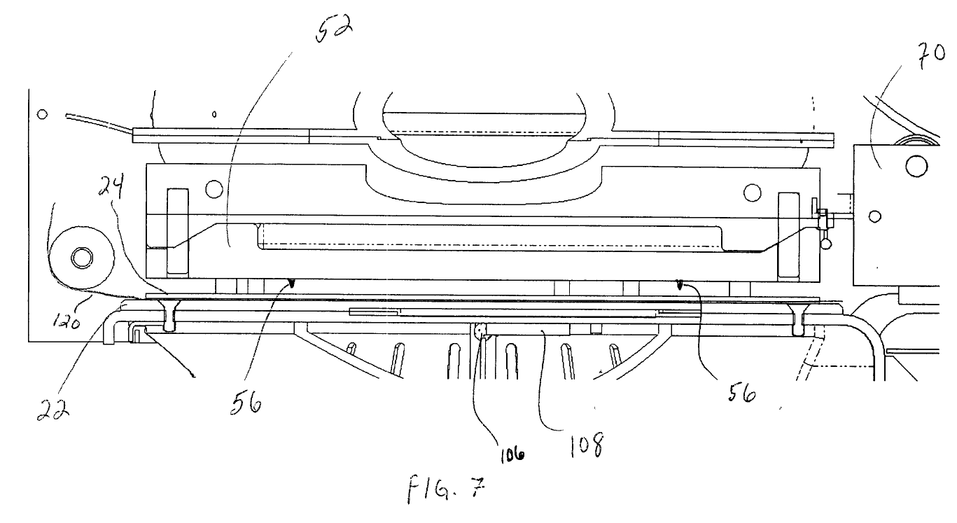

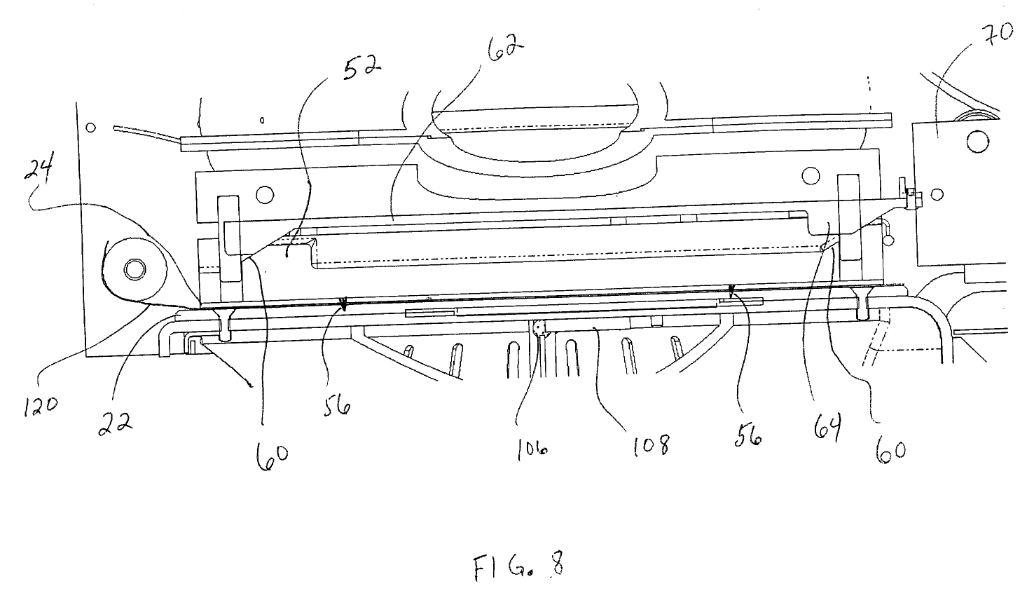

The operation of the film cutter will now be explained. FIG. 7 depicts a cutaway view of a preferred embodiment of the film cutter 20 in a stand-by position. The film 120 is located between the entry plate 22 and the guard plate 24. The cutting members 56 protrude beneath the housing plate 52, but do not protrude beneath the guard plate 24 or impinge on the film 120. Moreover the guard plate 24 does not contact the housing plate. When the linkage member solenoid 70 is activated, the elongated pushing members 62 are pulled toward the solenoid 70, as shown in FIG. 8. As the elongated pushing members 62 move toward the solenoid 70, the pushing member ramps 64 act downwardly on the pushing member groove ramps 60, thereby pushing the housing plate 52 downward such that the cutting members 56 contact the film 120, and such that the film cutter 20 is engaged.

After the film cutter 20 is engaged, the cutting belt driver 66 is activated, causing the cutting belt 50, along with the cutting members 56 to rotate. As the cutting members 56 rotate, the film 120 is cut. The degree of rotation is determined by the number of cutting members 56 used. For instance, if two cutting members 56 are used, the cutting belt 50 should rotate at least 180 degrees, that is, at least one-half of the circumference. On the other hand, if five cutting members 56 are used, the cutting belt need only travel at least seventy-two degrees, or at least one-fifth of the circumference.

Once the film 120 has been cut, an open-topped container (not shown) can be lifted through the openings in the film cutter, thereby contacting the film 120, and bringing the film 120 into contact with the double-ellipsoidal reflective hood activation sensor (not shown), such that the radiant energy source 112 is activated and the film is shrunk onto the open-topped container.

In one embodiment, the film cutter has a cup sensor 106 that senses the removal of the open-topped container from the heat-shrink apparatus. Upon removal of the open-topped container, the sensor 106 activates the film cutter 20 such that the film 120 is advanced and then cut as described above.

In another embodiment of the present invention, the film 120 is imprinted with a logo, drink indicator, or other markings. When this type of printed film is used, it is desired to advance the film 120 at specific intervals so that the markings line up correctly on the film. In this embodiment a film sensor 108 may be located on the entry plate 22 of the film cutter 20. In addition, the film 120 can be provided with an eye mark (not shown). In this arrangement, the film sensor 108 indicates how far the film should be advanced before it is cut.

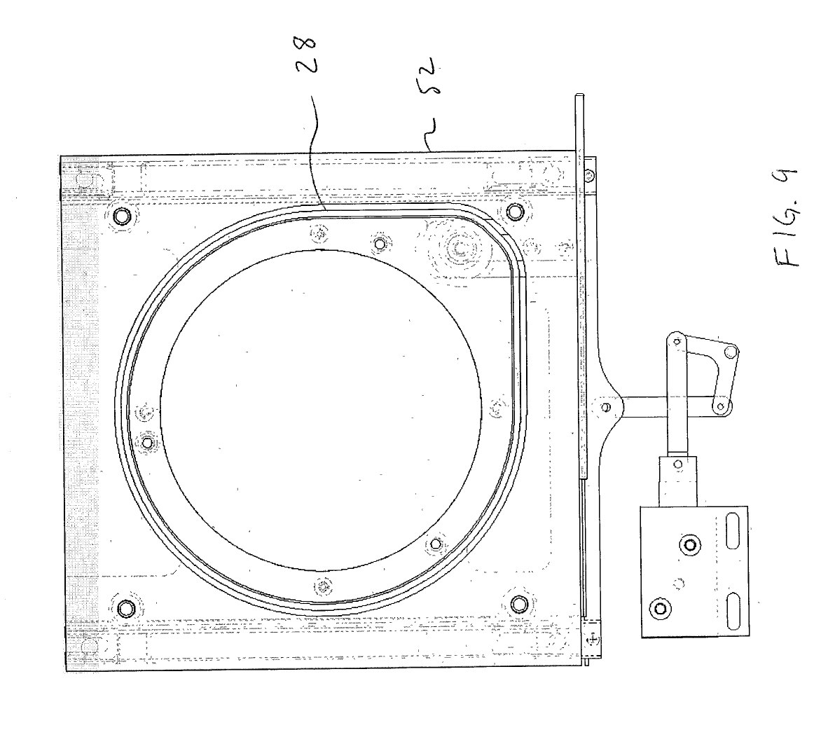

In another embodiment, depicted in FIG. 9, the film cutter 20 is configured to cut in a non-circular pattern. In this embodiment the film, after shrinking, has a tab, or protrusion, so that the user can easily remove the lid from the open-topped container, and replace the lid onto the open-topped container. As shown in FIG. 9, the cut-out pattern formed by the entry plate groove 28 and the guard plate 24 (not shown) and guard plate inner ring 36 (not shown) is non-circular, having a protrusion located on one side of the cut-out. In this embodiment, the housing plate 52, retaining ring 44, retaining groove 54, and cutting belt 50, are likewise non-circular. The operation of the film cutter 20 is as described above.

What is claimed is:

1. A film cutter comprising:
an entry plate and a guard plate capable of receiving a film therebetween;
the guard plate in communication with a housing plate having a lower surface and an upper surface, wherein the housing plate lower surface has a retaining groove capable of retaining a cutting belt and wherein the upper surface has pushing member grooves capable of receiving pushing members, the pushing member grooves having ramps;
pushing members having ramps, wherein the pushing members are positioned in the pushing member grooves of the housing plate; and
a cutting belt having cutting members, wherein the cutting belt is retained in the retaining groove, and wherein the cutting members do not extend past the guard plate when the film cutter is in a non-activated state.

2. The film cutter according to claim 1 wherein the guard plate has positioning members, the positioning members being received by receiving holes in the housing plate, and wherein the positioning members are capable of extending through the receiving holes in the housing plate.

3. The film cutter according to claim 2 wherein the guard plate further has spring members, and wherein the spring members are in communication with the housing plate.

4. The film cutter according to claim 1 further comprising a guard plate inner ring defining a guard plate groove between the guard plate inner ring and the guard plate and, wherein, the entry plate has an entry plate groove.

5. The film cutter according to claim 4 wherein the guard plate inner ring has positioning members, the positioning members being received by receiving holes in the retaining ring and further received by receiving holes in the housing plate, and wherein the guard plate has positioning members, the positioning members being received by receiving holes in the housing plate, and wherein the guard plate positioning members and guard plate inner ring positioning members are capable of extending through the receiving holes in the housing plate.

6. The film cutter according to claim 5 wherein the guard plate and the guard plate inner ring have spring members, and wherein the spring members are in communication with the housing plate.

7. The film cutter according to claims 2 or 5 further comprising a safety plate, wherein the safety plate is on the upper surface of the housing plate, wherein the safety plate has cutouts, and wherein the cutouts are in alignment with the housing plate receiving holes when the film cutter is in a closed position and are not in alignment with the receiving holes when the film cutter is in an open position.

8. The film cutter according to claim 1 wherein the cutting belt is a toothed gear belt.

9. The film cutter according to claim 8 further including a toothed cutting belt driver.

10. The film cutter according to claim 1 wherein the cutting belt is a smooth belt.

11. The film cutter according to claim I wherein the guard plate and the entry plate have openings capable of receiving an open-topped container.

12. The film cutter according to claim 4 wherein the entry plate groove and the guard plate groove are substantially circular.

13. The film cutter according to claim 4 wherein the entry plate groove and the guard plate groove are non-circular.

14. The film cutter according to claim 1 wherein the cutting belt has at least two cutting members.

15. The film cutter according to claim 14 wherein the cutting belt has at least five cutting members.

16. The film cutter according to claim 1 further comprising a cup sensor.

17. The film cutter according to claim 1 further comprising a film sensor.

18. The film cutter according to claim 1 further including a linkage member in communication with the pushing members.

19. The film cutter according to claim 18 including a solenoid in communication with the linkage member, wherein the solenoid is capable of displacing the linkage member.

20. A method of cutting film comprising the steps of:
providing a thin film between an entry plate and a guard plate;
providing a housing plate disposed opposite the guard plate having a retaining groove;
providing a cutting belt within the retaining groove the cutting belt having cutting members, wherein the cutting members extend below the retaining groove;
moving the housing plate into communication with the guard plate such that the cutting members are in communication with the film; and
rotating the cutting belt such that the cuffing members advance along the path of the cutting belt and cut the film.

21. The method of cutting film according to claim 20 wherein the guard plate has positioning members, the positioning members being received by receiving holes in the housing plate, and wherein the positioning members are capable of extending through the receiving holes in the housing plate.

22. The method of cutting film according to claim 21 wherein the guard plate further has spring members, and wherein the spring members are in communication with the housing plate.

23. The method of cutting film according to claim 20 further comprising a guard plate inner ring defining a guard plate groove between the guard plate inner ring and the guard plate, and, wherein, the entry plate has an entry plate groove.

24. The method of cutting film according to claim 23 wherein the guard plate inner ring has positioning members, the positioning members being received by receiving holes in the retaining ring and further received by receiving holes in the housing plate, and wherein the guard plate has positioning members, the positioning members being received by receiving holes in the housing plate, and wherein the guard plate positioning members and guard plate inner ring positioning members are capable of extending through the receiving holes in the housing plate.

25. The method of cutting film according to claim 24 wherein the guard plate and the guard plate inner ring have spring members, and wherein the spring members are in communication with the housing plate.

26. The method of cutting film according to claims 21 or 24 further comprising a safety plate, wherein the safety plate is on the upper surface of the housing plate, wherein the safety plate has cutouts, and wherein the cutouts are in alignment with the housing plate receiving holes when the film cutter is in a closed position and are not in alignment with the receiving holes when the film cutter is in an open position.

27. The method of cutting film according to claim 20 wherein the cutting belt is a toothed gear belt.

28. The method of cutting film according to claim 27 further including a toothed cutting belt driver.

29. The method of cutting film according to claim 20 wherein the cutting belt is a smooth belt.

30. The method of cutting film according to claim 20 wherein the guard plate and the entry plate have openings capable of receiving an open-topped container.

31. The method of cutting film according to claim 23 wherein the entry plate groove and the guard plate groove are substantially circular.

32. The method of cutting film according to claim 23 wherein the entry plate groove and the guard plate groove are non-circular.

33. The method of cutting film according to claim 20 wherein the cutting belt has at least two cutting members.

34. The method of cutting film according to claim 33 wherein the cutting belt has at least five cutting members.

35. The method of cutting film according to claim 20 further comprising a cup sensor.

36. The method of cutting film according to claim 20 further comprising a film sensor.

37. The method of cutting film according to claim 20 further including a linkage member in communication with the pushing members.

38. The method of cutting film according to claim 37 including a solenoid in communication with the linkage member, wherein the solenoid is capable of displacing the linkage member.

39. An apparatus for cutting a film and heat-shrinking the film onto an open-topped container comprising:
a reflective hood having a reflective interior surface;
a radiant energy source;
a reflective shield, the reflective hood and the reflective shield being configured to concentrate radiant energy from the radiant energy source about the periphery of the opening in the lower portion of the hood; and
a film cutter in communication with the reflective hood system.

40. The apparatus according to claim 39, the film cutter further comprising an entry plate and a guard plate capable of receiving a film therebetween;
the guard plate in communication with a housing plate having a lower surface and an upper surface, wherein the housing plate lower surface has a retaining groove capable of retaining a cutting belt and wherein the upper surface has pushing member grooves capable of receiving pushing members, the pushing member grooves having ramps;
pushing members having ramps, wherein the pushing members are positioned in the pushing member grooves of the housing plate; and
a cutting belt having cutting members, wherein the cutting belt is retained in the retaining groove, and wherein the cutting members do not extend past the guard plate when the film cutter is in a non-activated state.

41. The apparatus according to claim 39 wherein the reflective hood has a curvilinear surface of revolution.

42. The apparatus according to claim 41 wherein the reflective hood is a double ellipsoidal hood.

43. The apparatus according to claim 42 wherein a surface of the double ellipsoidal hood is coated with a material to enhance surface reflectivity.

44. The apparatus according to claim 43 wherein a surface of the double ellipsoidal reflective hood is coated with a gold or silver metallic reflective surface.

45. The apparatus according to claim 42 wherein the double ellipsoid reflective hood has first and second focal rings, and wherein one of the first or second focal rings is coincident with the periphery of the opening in the lower portion of the hood.

46. A method for cutting a film and heat-shrinking the film onto an open-topped container comprising:
cutting a heat shrink film with a film cutter in communication with a reflective hood system;
contacting the opening of an open-topped container with the cut heat shrink film; and
subjecting the covered container to radiant energy radiant energy having visible and near infrared wavelengths directed by said reflective hood system.

47. The method according to claim 46 further comprising:
providing the heat-shrink film between an entry plate and a guard plate;
providing a housing plate disposed opposite the guard plate having a retaining groove, the retaining groove further having a cutting belt having cutting members, wherein the cutting members extend below the retaining groove;
moving the housing plate towards the guard plate and entry plate such that the cutting members are in communication with the film; and
rotating the cutting belt such that the cutting members advance along the path of the cutting belt and cut the film.

48. The method according to claim 46 wherein a first portion of the radiant energy reflects along a surface of the reflective hood and is ultimately directed to an area below the brim of the open-topped container, thereby shrinking the heat-shrink film and wherein, the portion of the heat-shrink film located under the reflective shield is substantially shielded from impingement by the first portion of radiant energy.

49. The method according to claim 48 wherein a second portion of the radiant energy reflects off a surface of the reflective shield and impinge on a surface of the reflective hood and is ultimately directed to an area below the brim of the open-topped container, thereby shrinking the heat-shrink film, and, wherein the portion of the heat-shrink film located under the reflective shield is substantially shielded from impingement by the second portion of radiant energy.

50. The method according to claim 46 wherein the reflective hood has a curvilinear surface of revolution.

51. The method according to claim 50 wherein the reflective hood is a double ellipsoidal hood.

52. The method according to claim 51 wherein a surface of the double ellipsoidal hood is coated with a material to enhance surface reflectivity.

53. The method according to claim 51 wherein a surface of the double ellipsoidal reflective hood is coated with a gold or silver metallic reflective surface.

54. The method according to claim 51 wherein the double ellipsoidal reflective hood has first and second focal rings, wherein one of the first or second focal rings is coincident with the periphery of the opening in the lower portion of the hood, and wherein the radiant energy is concentrated at the focal ring coincident with the periphery of the opening in the lower portion of the hood.

55. A method of cutting film comprising the steps of:
providing a thin film between an entry plate and a guard plate;
providing a housing plate, wherein the housing plate retains a cutting belt having cutting members, wherein the cutting members do not extend below the guard plate;
moving the housing plate into communication with the guard plate such that the cutting members extend below the guard plate and are in communication with the film; and
rotating the cutting belt such that the cutting members advance along the path of the cutting belt and cut the film.

56. An apparatus for cutting a film and heat-shrinking the film onto an open-topped container comprising:
a reflective hood having a reflective interior surface;
a radiant energy source;
a reflective shield, the reflective hood and the reflective shield being configured to concentrate radiant energy from the radiant energy source about the periphery of the opening in the lower portion of the hood; and
a film cutter in communication with the reflective hood system comprising an entry plate and a guard plate capable of receiving a film therebetween;
the guard plate in communication with a housing plate, wherein the housing plate is capable of retaining a cutting belt; and
a cutting belt having cutting members, wherein the cutting belt is retained in the housing plate, and wherein the cutting members do not extend past the guard plate when the film cutter is in a non-activated state.

57. A method for cutting a film and heat-shrinking the film onto an open-topped container comprising:
providing a thin heat-shrink film between an entry plate and a guard plate;
providing a housing plate, the housing plate retaining a cutting belt having cutting members, wherein the cutting members do not extend below the guard plate;
moving the housing plate towards the guard plate and entry plate such that the cutting members extend beyond the guard plate and are in communication with the film; and
rotating the cutting belt such that the cutting members advance along the path of the cutting belt and cut the film;
and further comprising contacting the opening of an open-topped container with the cut film;
placing the covered open-topped container at an opening of a reflective hood, wherein a portion of the lower opening of the reflective hood is covered by a reflective shield; and
subjecting the covered container to radiant energy having visible and near infrared wavelengths.

58. The method according to claim 57 wherein a first portion of the radiant energy reflects along a surface of the reflective hood and is ultimately directed to an area below the brim of the open-topped container, thereby shrinking the heat-shrink film and wherein, the portion of the heat-shrink film located under the reflective shield is substantially shielded from impingement by the first portion of radiant energy.

59. A film cutter comprising:
an entry plate and a guard plate capable of receiving a film therebetween;
the guard plate in communication with a housing plate, wherein the housing plate is capable of retaining a cutting belt; and
a cutting belt having cutting members, wherein the cutting belt is retained by the housing plate, and wherein the cutting members do not extend past the guard plate when the film cutter is in a non-activated state.

60. The film cutter according to 59 wherein the housing plate has a lower surface and an upper surface, and wherein the housing plate lower surface has a retaining groove capable of retaining a cutting blade.

61. The film cutter according to claim 60 wherein the housing plate upper surface has pushing member grooves capable of receiving pushing members, and wherein the pushing members are positioned in the pushing member grooves.

62. The film cutter according to claim 61 wherein the pushing member grooves having ramps and wherein the pushing members have ramps.

63. The film cutter according to claim 59 wherein the guard plate has positioning members, the positioning members being received by receiving holes in the housing plate, and wherein the positioning members are capable of extending through the receiving holes in the housing plate.

64. The film cutter according to claim 63 wherein the guard plate further has spring members, and wherein the spring members are in communication with the housing plate.

65. The film cutter according to claim 59 further comprising a guard plate inner ring defining a guard plate groove between the guard plate inner ring and the guard plate and, wherein, the entry plate has an entry plate groove.

66. The film cutter according to claim 65 wherein the guard plate inner ring has positioning members, the positioning members being received by receiving holes in the retaining ring and further received by receiving holes in the housing plate, and wherein the guard plate has positioning members, the positioning members being received by receiving holes in the housing plate, and wherein the guard plate positioning members and guard plate inner ring positioning members are capable of extending through the receiving holes in the housing plate.

67. The film cutter according to claim 66 wherein the guard plate and the guard plate inner ring have spring members, and wherein the spring members are in communication with the housing plate.

68. The film cutter according to claims 63 or 66 further comprising a safety plate, wherein the safety plate is on the upper surface of the housing plate, wherein the safety plate has cutouts, and wherein the cutouts are in alignment with the housing plate receiving holes when the film cutter is in a closed position and are not in alignment with the receiving holes when the film cutter is in an open position.

69. The film cutter according to claim 59 wherein the cutting belt is a toothed gear belt.

70. The film cutter according to claim 69 further including a toothed cutting belt driver.

71. The film cutter according to claim 59 wherein the cutting belt is a smooth belt.

72. The film cutter according to claim 59 wherein the guard plate and the entry plate have openings capable of receiving an open-topped container.

73. The film cutter according to claim 65 wherein the entry plate groove and the guard plate groove are substantially circular.

74. The film cutter according to claim 65 wherein the entry plate groove and the guard plate groove are non-circular.

75. The film cutter according to claim 59 wherein the cutting belt has at least two cutting members.

76. The film cutter according to claim 75 wherein the cutting belt has at least five cutting members.

77. The film cutter according to claim 59 further comprising a cup sensor.

78. The film cutter according to claim 59 further comprising a film sensor.

79. The film cutter according to claim 61 further including a linkage member in communication with the pushing members.

80. The film cutter according to claim 79 including a solenoid in communication with the linkage member, wherein the solenoid is capable of displacing the linkage member.

81. A method of cutting a film including the steps of:
providing a thin film between a guard plate and an entry plate;
providing cutting members that do not extend below the guard plate;
moving the cutting members in a direction such that the cutting members extend below the guard plate and contact the film; and
advance the cutting members to cut the film.

82. The film cutter according to claim 1 wherein the cutting belt has at least three cutting members.

83. The film cutter according to claim 1 wherein the cutting belt has at least four cutting members.

84. The film cutter according to claim 33 wherein the cutting belt has at least three cutting members.

85. The film cutter according to claim 33 wherein the cutting belt has at least four cutting members.

86. The film cutter according to claim 75 wherein the cutting belt has at least three cutting members.

87. The film cutter according to claim 75 wherein the cutting belt has at least four cutting members.

88. The method according to claim 46 wherein the covered open-topped container is placed at an opening of a reflective hood, wherein a portion of the opening of the reflective hood is covered by a reflective shield.

89. A film cutter comprising:
a film cutting apparatus; and
a cutting belt, wherein the cutting belt has at least three cutting members.

90. The film cutter according to claim 89 wherein the cutting belt has at least four cutting members.

91. The film cutter according to claim 89 wherein the cutting belt has at least five cutting members.

92. A method of cutting a film wherein a film is provided to a cutting belt having at least three cutting members and wherein the belt is rotated to cut the film.
